(19) United States
(12) Patent Application Publication
(10) Pub. No.: US 2020/0036242 A1
(43) Pub. Date: Jan. 30, 2020

(54) ELECTRIC MACHINE WITH FLUX SWITCHING WITH SIMPLE EXCITATION

(71) Applicants: CNAM - Conservatoire National Des Arts Et Metiers; Ecole Normale Superiere De Cachan

(72) Inventors: Benjamin GAUSSENS, Lamasquere (FR); Roger Michel LECRIVAIN, Ivry Sur Seine (FR); Mohammed GABSI, Cachan (FR)

(73) Assignees: Ecole Normale Superiere De Cachan, Cachan (FR); CNAM - Conservatoire National Des Arts Et Metiers, Paris (FR); Centre National De La Recherche Scientifique (CNRS), Paris (FR); Ecole Normale Superiere De Cachan, Cachan (FR)

(21) Appl. No.: 15/735,124

(22) PCT Filed: Jun. 8, 2016
(86) PCT No.: PCT/EP2016/062962

§ 371 Date: Dec. 8, 2017

(30) Foreign Application Priority Data
Jun. 9, 2015 (FR) 1555264

(51) Int. Cl. H02K 1/17; H02K 41/03; H02K 21/40

(52) U.S. Cl. CPC H02K 1/17; H02K 29/03; H02K 21/40; H02K 41/033

(57) ABSTRACT

The proposed invention is an electric machine with flux switching comprising: —a movable element (20), comprising a plurality of flux switching teeth, and —a stator (10), comprising a plurality of teeth, excitation coils (15) and armature coils, characterized in that the stator is formed of a succession of elementary cells each comprising: —three teeth, comprising a central tooth (120) and two lateral teeth (121), delimiting therebetween two central notches (140), an excitation coil being housed in the central notches and wound around the central tooth, and —two lateral half-notches (141) on either side of the lateral teeth, each half-notch housing at least in part an armature coil, in such a way that two successive elementary cells share a common lateral notch.

### FIELD OF THE INVENTION

The invention relates generally to electric machines. It relates in particular to a flux-switching electrical machine. The invention relates in particular to a so-called simple excitation machine, i.e. one comprising only a single source of magnetic excitation, namely excitation windings, the machine having no magnets.

### STATE OF THE ART

Electric machines are used in varied applications, in particular as alternators, for example for motor vehicles or for aircraft.

Among these electrical machines, flux-switching rotary machines comprise a rotor and a stator, the stator carrying all the electrically or magnetically active means of the machine, i.e. all the magnets and/or excitation coils or armature coils. Analogous linear machines exist, in which the rotor is replaced by a movable element in translation with respect to the stator. The rotor—or movable element—is for its part not equipped with magnet or winding, and is made of a ferromagnetic material allowing the circulation of a magnetic field. For this reason, flux-switching machines are exempt from using rubbing contacts (brushes), they have greater mechanical strength and are more reliable in operation. In addition, the rotor of a flux-switching machine is simpler and therefore less costly to produce.

Known for example is a flux-switching device according to document EP 2 002 529.

This machine includes a rotor, not equipped with active electric or magnetic means, and a stator. The stator is subdivided into a set of basic cells such that each cell comprises a permanent magnet as well as notches housing an armature winding and at least a portion of an excitation winding.

This machine has already given good service in that it allows in particular control of the induced voltage.

However, this machine has the characteristic of being a double-excitation machine, i.e. it includes both excitation windings and permanent magnets.

However, permanent magnets are very costly today and considerably increase the cost of production of such a machine.

It is therefore preferably to use and to produce simple excitation machine in which the excitation is accomplished by excitation windings, said machines containing no permanent magnets.

Such a machine has been proposed in document WO 2013/068947. This machine has a stator carrying only excitation windings and armature windings. In addition, each excitation winding is accommodated in a pair of notches separated by at least three teeth.

These three teeth form between them two notches allowing the accommodation of armature windings. However, in order for this machine to operate, it is necessary that the armature windings accommodated in these notches correspond to different phases, i.e. that the excitation windings be crossed with each of the armature windings.

This crossing of windings makes manufacture of the machine complex and makes the disposition of each winding less compact. For this reason, the overall bulk of the machine is increased. Moreover, although the document indicates limiting the cost of production by limiting the quantity of copper necessary for forming the excitation windings, the extension of copper wire necessary for crossing the excitation windings with the armature windings reduces this saving, or even generates excess cost in production of the machine.

The excess copper wire necessary in crossing the windings is also the source of energy losses, because the energy dissipated in copper wire is proportional to the resistance of the wires, which itself depends on their length.

### PRESENTATION OF THE INVENTION

One of the aims of the invention is to propose an electric machine of which the bulk and the cost of production are reduced with respect to the prior art.

In particular, one aim of the invention is to propose an electric machine which can operate without a permanent magnet, and without crossing windings.

In this regard, the invention relates to a flux-switching electrical machine comprising:
a movable element, comprising a plurality of flux-switching teeth, and
a stator, comprising a plurality of teeth, excitation windings and armature windings,
   characterized in that the stator is formed of a succession of basic cells each comprising:
three teeth, comprising a central tooth and two lateral teeth, delimiting between them two central notches, an excitation winding being accommodated in the central notches and wound around the central tooth, and
two lateral half-notches on either side of the lateral teeth, each half-notch accommodating at least in part an armature winding, so that two successive basic cells share a common lateral notch.
Advantageously but optionally, the machine according to the invention can also comprise at least one of the following features: wherein the central tooth of a basic cell of the stator can comprise a top having an angular opening θ_{c} comprised between 0.6*θ and 0.75*θ, where θ is the angular opening of the average deviation between two consecutive teeth of the stator, defined by

$$ϑ = \frac{2 π}{N} ,$$

where N is the number of teeth of the stator.
each lateral tooth of a basic cell of the stator can comprise a top having an angular opening θᵢ comprised between 0.4*θ and 0.7*θ, where θ is the angular opening of the average deviation between two consecutive teeth of the stator, defined by

$$ϑ = \frac{2 π}{N} ,$$

where N is the number of teeth of the stator.
the lateral teeth of a basic cell of the stator can be distant from the central tooth by a deviation comprised between θ and 1.15*θ, where θ is the angular opening of the average deviation between two consecutive teeth of the stator, defined by

$$ϑ = \frac{2 π}{N} ,$$

where N is the number of teeth of the stator.
the teeth of a basic cell of the stator can have a width at their base greater than the width at their top.
the armature windings can be distributed into a number Q of armature phases greater than or equal to 1, and the stator comprises a number N of teeth such that

N=3nQ

where n is the number, greater than or equal to 1, of windings per armature phase.
According to one embodiment, the machine being of the rotary machine type and the movable element being a rotor, N is even and the number of teeth of the rotor is even.
each armature winding can be received in the two lateral notches of a basic cell and wound around the three teeth of the cell.
the armature windings can be disposed so that there is no crossing between them.
each basic cell can comprise an armature winding wound around its three teeth and the armature windings can be distributed into three phases A, B and C disposed so that:
   the windings of the same phase are wound around the teeth of adjacent cells, or
   the windings of three consecutive cells all correspond to a different phase.
the lateral notches of at least one basic cell can accommodate portions of different armature windings.
each basic cell of the stator can further comprise at least one permanent magnet.
each basic cell can comprise a permanent magnet accommodated in the central tooth or two permanent magnets received respectively in the central notches.
In one embodiment, the machine comprises an axial stack of stators and movable elements, and only a fraction of the stator length includes permanent magnets.

The proposed electric machine includes a succession of basic cells comprising three teeth delimiting two central notches in which an excitation winding is accommodated, and lateral notches which can accommodate at least a portion of at least one armature winding.

This machine is a flux-switching machine wherein the rotor or the movable element has no electrically or magnetically active elements such as permanent magnets or windings. Moreover, the stator can also have no permanent magnets, so that the machine can operate with excitation only by excitation windings. The cost of production of this machine is therefore reduced with respect to a machine comprising permanent magnets.

Moreover, the configuration of the cells allows in particular a configuration in which the lateral notches of a cell accommodate an armature winding surrounding the excitation winding.

This type of configuration has reduced bulk and cost due to the absence of crossing between the excitation winding and the armature winding(s). The machine is also simpler to produced and more effective because the necessary winding lengths are reduced with respect to crossed windings.

It has also been discovered that, by reducing the width of the lateral teeth with respect to that of the central tooth of a basic cell, the performance of the machine is improved because the torque produced by the machine is smoothed over time (reduction in torque ripple).

Finally, in the case where this machine is of the rotary machine type, it advantageously allows configurations in which the number of teeth of the rotor and the number of armature windings per phase is even, which allows balancing of the magnetic forces in play on the circumference of the machine and avoids a magnetic imbalance which would degrade the performance and/or the lifetime of the machine.

### DESCRIPTION OF THE FIGURES

Other features, aims and advantages of the invention will be revealed by the description that follows, which is purely illustrative and not limiting, and which must be read with reference to the appended drawings, in which:

FIG. 1 shows schematically a machine according to one embodiment of the invention,

FIGS. 2a and 2b illustrate a basic cell of a machine according to an embodiment of the invention and the passage of flux in this cell in two relative positions of the teeth of the rotor with respect to the cell,

FIGS. 3a and 3b show the distribution of field lines in a machine in two relative positions of the rotor and the stator,

FIGS. 4a to 4e show possible configurations of the armature windings in a machine according to one embodiment of the invention,

FIG. 5a shows the notation conventions regarding the geometry of the teeth of the stator.

FIGS. 5b to 5d show variants embodiments of the teeth of the stator,

FIG. 6 shows the performance obtained by different machines including those of FIGS. 4a to 4e.

FIGS. 7a to 7e show variant embodiments of a machine comprising permanent magnets.

FIGS. 8a and 8b show respectively rotor and stator plates of a machine prototype.

### DETAILED DESCRIPTION OF AT LEAST ONE EMBODIMENT OF THE INVENTION

### Structure of the Machine

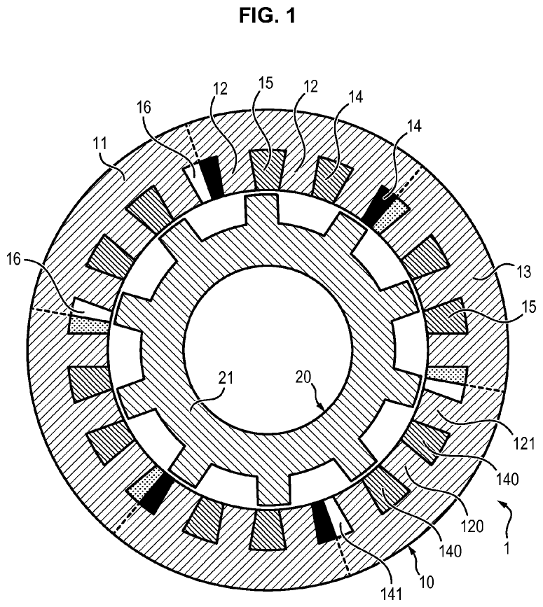

With reference to FIG. 1, a flux-switching electric machine 1 according to an embodiment of the invention is shown schematically.

The machine shown in FIG. 1 is a rotary machine including a stator 10 and a rotor 20. The stator and the rotor extend coaxially one around the other. The stator 10 is fixed and the rotor 20 is movable in rotation around the common axis of the stator and of the rotor.

In FIG. 1, the stator 10 extends around the rotor 20. However, the reverse can also be implemented, in which the rotor extends around the stator.

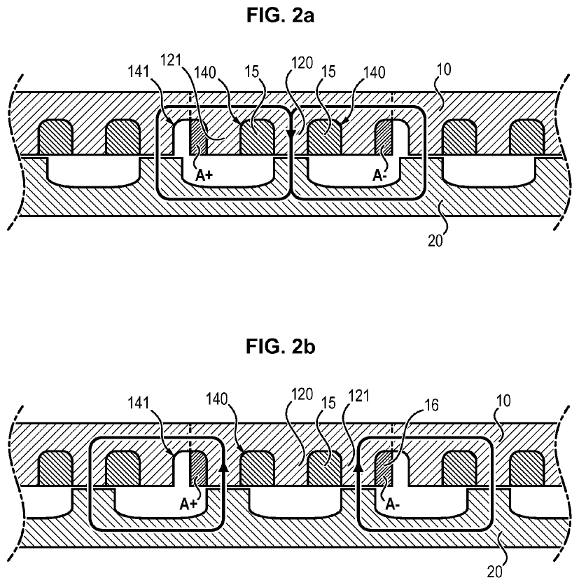

Moreover, the machine 1 could also be a linear machine in which the stator 10 extends rectilinearly and the rotor 20 is replaced by an element movable in translation with respect to the stator. This case is shown in FIGS. 2a and 2b.

Hereafter, a general terminology is used to designate the movable portion of a machine, whether linear or rotary. Movable element can therefore also designate a rotor.

The movable element 20 has no electrically or magnetically active means, and in particular has no windings and no magnets. The rotor is made of a ferromagnetic material suitable for allowing circulation of a magnetic field. By way of a non-limiting example, the movable element 20 can be made of iron-silicon or iron-cobalt alloy, or of steel.

The movable element 20 comprises a base, for example in the form of a ring 21 in the case where this is the rotor of a rotary machine and a set of teeth 22 extending from the base 21 toward the stator.

In the case of a rotary machine, the teeth 22 extend substantially radially from the ring 21. If, as in FIG. 1, the rotor is inside the stator, the teeth 22 extend radially toward the outside with respect to the ring.

The stator 10 is also made of a ferromagnetic material, for example iron or steel. It comprises a base, for example in the form of a ring 11 in the case of a rotary machine, and a plurality of teeth 12 extending from the base 11 toward the movable element 20, the teeth 12 being separated by notches 14.

The stator 10 is organized into a succession of basic cells 13, each cell cooperating with one or more teeth of the movable element 20 to form therewith a magnetic field loop with a direction that varies depending on the movement of the movable element. Preferably, this result is achieved when the deviation between two successive teeth of the movable element corresponds to the deviation between two teeth of the stator separated by a third tooth.

With reference to FIGS. 2a and 2b, in which an electric machine of the linear type is shown, each basic cell 13 includes three successive teeth 12, including a central tooth 120 and two lateral teeth 121 situated on either side of the central tooth 120.

Each basic cell 13 also includes two central notches 140, which are the spaces formed between the central tooth 120 and each of the two lateral teeth 121; and two lateral half-notches 141 extending on either side of the lateral teeth 121.

It will be understood that the lateral half-notches 141 of two adjacent basic cells 13 join together to form a common notch 14 between two successive teeth of the stator 10, and therefore that two successive cells share a common notch.

The stator 10 also comprises a magnetic excitation source in the form of excitation windings 15.

The stator 10 comprises a plurality of excitation windings 15, in a number equal to the number of basic cells, each basic cell 13 comprising an excitation winding 15 wound in the central notches 140 so as to surround the central tooth 120, as can be seen in FIGS. 2a and 2b.

According to a preferred embodiment, the excitation windings 15 of the stator are the only magnetic excitation source of the machine 1. In particular, the stator does not in this case comprise any permanent magnet. As has been shown previously, the rotor—or movable element—does not comprise a magnetic excitation source: nor an excitation winding, nor a permanent magnet. The machine 1 is therefore a flux-switching machine with simple excitation.

As a variant, it is nevertheless possible to desire that the machine 1 have double excitation and comprise permanent magnets to provide an electromotive force for the machine even without an excitation current.

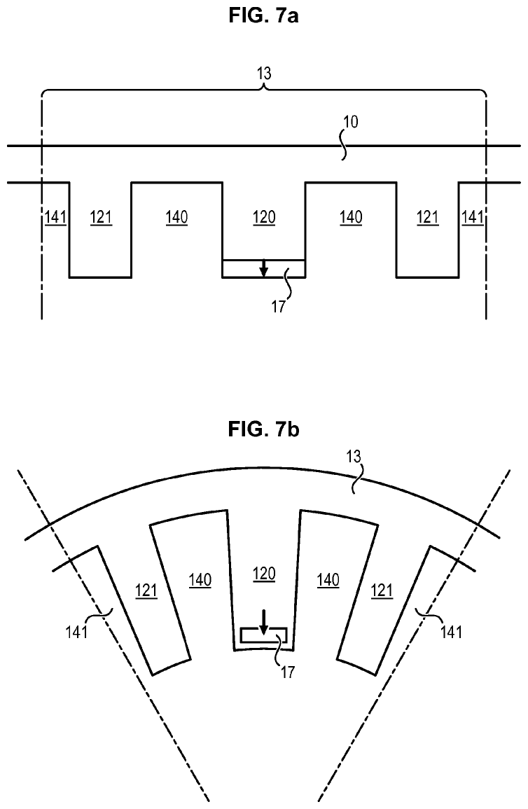

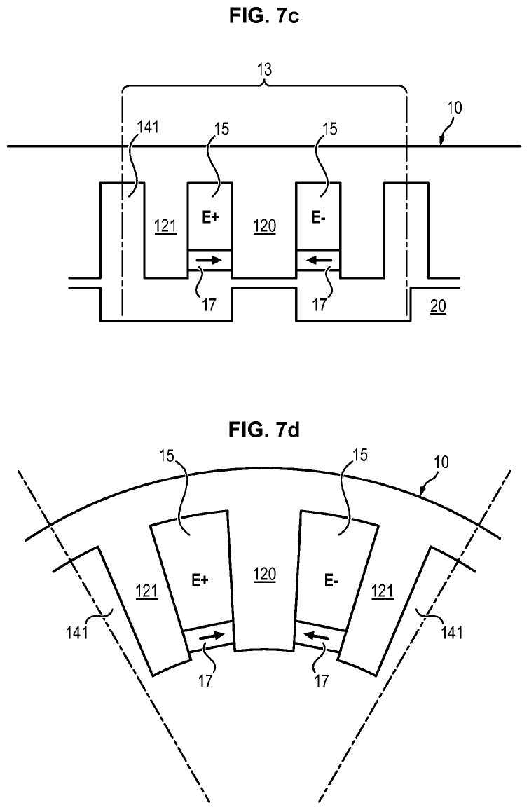

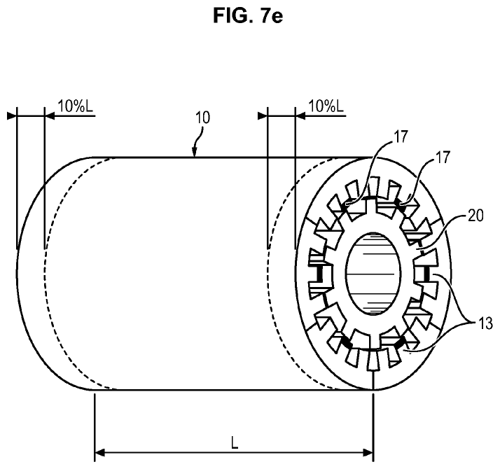

In this case, with reference to FIGS. 7a to 7e, the stator 10 can comprise permanent magnets 17.

According to a first embodiment shown in FIGS. 7a and 7b, each magnet 17 is accommodated in a central tooth 120 of a basic cell 13, either in a cavity provided for this purpose as in FIG. 7a, or at the top of the central tooth 120 as in FIG. 7b. In the latter case the central tooth 120 is truncated so that the cumulative height of the central tooth 120 and the magnet 17 with respect to the base is strictly less than the distance between the base and an opposite tooth of the movable element. Thus, there remains an air-gap between one tooth of the movable element 22 and the tooth 120 topped by the magnet 17 of the stator.

In FIG. 7a, the machine is linear, and in FIG. 7b it is rotary. Naturally, this is not limiting, and the linear or rotary type of the machine can be combined with any implementation of a permanent magnet.

According to an alternative embodiment shown in FIGS. 7c and 7d, each basic cell 13 can receive two permanent magnets 17 accommodated in the central notches 140 of the cell.

Thus, each central notch 140 receives a portion of an excitation winding 15 and a magnet 17. In FIGS. 7c and 7d, the portion of the excitation winding 15 received in a notch 140 is disposed against the bottom of the notch, so as to be interleaved between the base 10 of the stator and the magnet 17.

As a variant, the permanent magnet 17 can be positioned between the bottom of the notch 140 and the excitation winding 15.

With reference to FIG. 7e, the electric machines, whether rotary or linear, can be formed by stacks of stators 10 and movable elements 20.

In the case of a rotary machine, the stacking is accomplished in the axis of rotation of the rotor 20. In the case of a linear machine, the stacking is accomplished along an axis orthogonal to an axis of movement of the movable element.

In the case where the machine 1 is made with this type of stacking and comprises magnets 17, it is advantageous that the magnets 17 are found only on the stators 10 situated at the end of the stack.

For example, if the machine has a length L in the stacking direction, the stators equipped with magnets are advantageously those comprised between 0 and 20% of L on the one hand and between 80 and 100% of L on the other hand, preferably comprised between 0 and 10% of L on the one hand, and between 90 and 100% of L on the other hand.

Thus, as the permanent magnets 17 generate a magnetic field which perturbs the field generated by the excitation windings 15, the fact of confining the magnets to the ends of the machine allows perturbations to be limited, which still limiting the number of magnets and therefore the cost of the machine.

Returning to FIGS. 2a and 2b, the stator 10 comprises a plurality of armature windings 16. As described in more detail hereafter, the armature windings 16 can be distributed into one or more phases, depending on whether the machine 1 is single-phase or polyphased.

Preferably, but without limitation, in the case where the machine is a rotary machine, the armature windings are distributed into a number of phases Q greater than or equal to 1, and the stator 10 comprises a number N of teeth 12, such that

N=3nQ

Where n is the number, greater than or equal to 1, of windings per armature phase.

Advantageously, N is even and the number of teeth 22 of the rotor is also even.

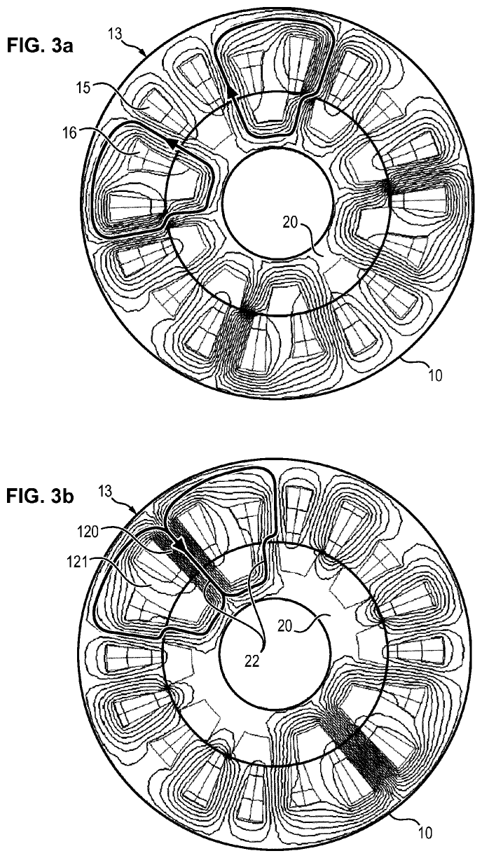

This allows, as can be seen in particular in FIGS. 3a and 3b, obtaining a symmetric magnetic field in the machine no matter what the relative position of the rotor with respect to the stator.

An asymmetric concentration of the magnetic field is therefore avoided, which would induce a magnetic imbalance phenomenon analogous to a mechanical imbalance phenomenon on a rotating object of which the mass is not homogeneously distributed.

In the example of FIGS. 1, 3a to 4e and 5b to 5d, the rotor comprises 10 teeth, and the stator has 6 basic cells, each comprising three teeth, or 18 teeth. The rotor comprises one excitation winding 15 per cell, or 6 windings.

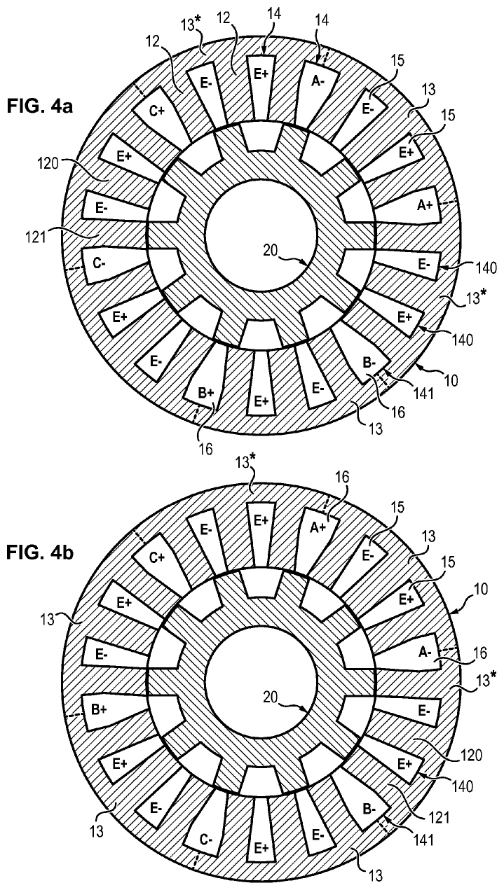

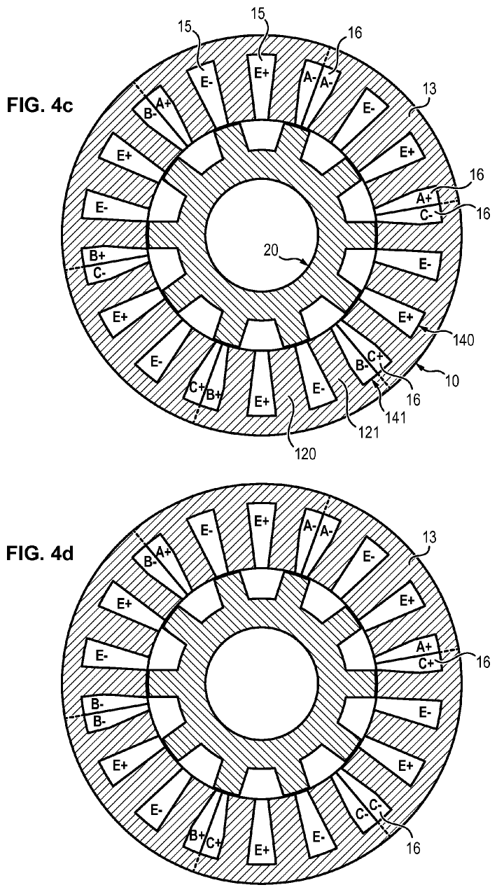

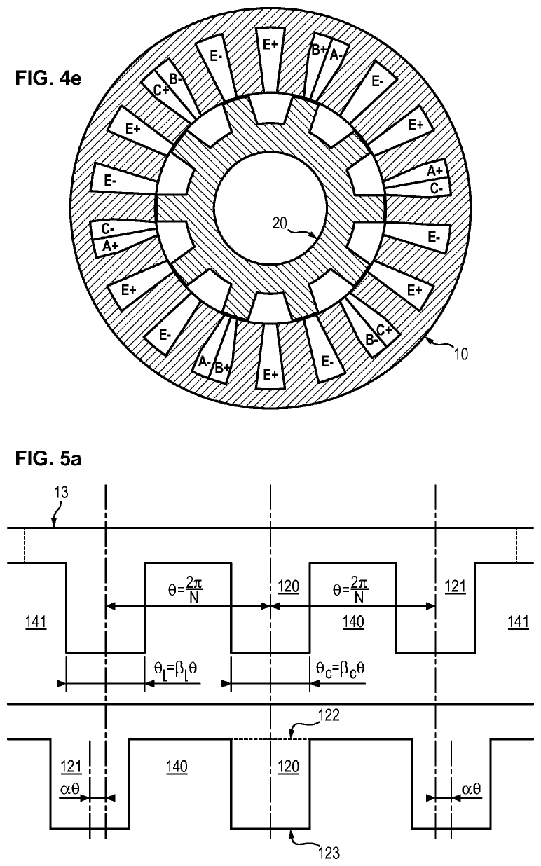

The number of phases is advantageously greater than or equal to 3, or greater than or equal to 5 if that is allowed by the number of teeth of the stator. In FIGS. 4a to 4e, the number of phases is equal to 3 with, in FIGS. 4a and 4b, a single winding per phase (so-called single-layer windings), or three armature windings in total, and in FIGS. 4c to 4e, two armature windings per phase (so-called double-layer windings), or 6 armature windings in total.

All the armature and excitation windings 15, 16 are made of an electrically conductive material, preferably of copper or a copper-based alloy.

Each lateral half-notch 141 of a basic cell 13 accommodates a portion of at least one armature winding 16.

As, for a given basic cell, an excitation winding is wound around the central tooth and the armature windings are received in the lateral half-notches, there is no crossing between the excitation windings and the armature windings, which facilitates the manufacture of the machine, and reduces its bulk and the quantity of material necessary for making the windings.

According to one particularly advantageous embodiment conforming to the example shown in FIGS. 2a and 2b, each armature winding 16 is wound in the lateral half-notches 141 of a basic cell 13, around lateral teeth 121, so as to also surround the excitation winding 15 located in the central notches without surrounding the tooth of an adjacent cell.

This embodiment makes it possible to avoid any crossing between windings, including between the armature windings, and therefore to further simplify the manufacture of the machine 1, to limit the bulk of the machine and to further reduce the cost by reducing the length of the necessary windings.

Other configuration examples are detailed hereafter with reference to FIG. 4a to 4e.

### Operation of the Machine

The operation of the machine 1 describe previously is explained with reference to FIGS. 2a and 2b as well as to FIGS. 3a and 3b, illustrating the field lines in the machine 1 depending on the different relative positions of the rotor or movable element 20 and of the stator 10. This operation is identical, whether the machine is linear or rotary.

Relative movement (rotary or translational), of the movable element or rotor 20 with respect to the stator 10 implies that each basic cell 13 “sees” successively the alternation of the two following configurations:
In a first configuration visible in FIGS. 2a and 3a (the form of the magnetic field being indicated for the basic cell concerned), one tooth 22 of the movable element 20 is located facing the central tooth 120 of a basic cell 13 of the stator. One magnetic field loop is then formed passing successively:
   in the central tooth 120 of a basic cell 13 of the stator,
   in the tooth 22 of the movable element facing it,
   then in the ring or base 11 of the stator,
   then return to the movable element 20 by the two teeth 22 thereof adjacent to the first, and by two lateral teeth 121 of basic cells of the stator located on either side of the first,
   and finally, return to the central tooth 120 of the first basic cell 13 through the ring or base 11 of the stator.
In a second configuration shown in FIGS. 2b and 3b, two teeth 22 of the movable element 20 are located facing the two lateral teeth 121 of the basic cell of the stator. Two magnetic field loops are then formed, passing successively:
   From one tooth of the stator 22, into a lateral tooth 121 of the cell located facing it,
   Into the ring or base 11 of the stator,
   Into the central tooth 120 of the basic cells 13 located on either side of the first,
   Into the teeth of the movable element located facing it,
   The return to the tooth of the stator located facing the first basic cell via the base 21 of the movable element 20.
      In this manner, when constant electrical current passes in the excitation windings and the movable element is driven into motion with respect to the stator, each armature winding is subjected to an alternating magnetic field, inducing an alternating voltage in said armature winding.

### Dispositions of the Phase Windings

As indicated earlier, several configurations of armature windings in the lateral notches 141 can be considered for the same number of phases.

In the illustrations of the different configurations in 4a to 4e, the non-limiting example of the rotary machine 1 shown comprises 6 basic cells and three armature phases A, B, and C (Q=3 according to the preceding notation). The same configuration can be transposed to the case of a linear machine.

In the first place, the armature winding can be called “single layer,” i.e. each notch formed by two adjacent lateral half-notches 141 receives only a single armature winding 16.

In the case of a single layer winding, the armature windings are preferably arranged so that there is no winding crossing. In this case, the stator comprises alternately:
One basic cell 13 in which an armature winding is wound around its three teeth and around an excitation winding, and
One basic cell 13* in which only one excitation winding is wound around the central tooth.

This case is shown in the non-limiting example of FIG. 4a which includes three basic cells 13* and three basic cells 13 each comprising one winding corresponding respectively to each of the phases A, B and C.

Alternatively, the armature windings can also be arranged so as to allow crossing of windings. In this case, the machine 1 can comprise one or more armature windings 15 each wound around the three teeth of a single basic cell, and one or more armature windings 15 wound around two or more adjacent basic cells.

This case is shown in the non-limiting example of FIG. 4b, in which the machine still comprises 6 basic cells. A basic cell comprises an armature winding of phase A wound around its three teeth 12, and armature windings of phases B and C are crossed by each being wound around the teeth forming two successive basic cells 13. There remain two cells 13* in which the excitation winding is not surrounded by an armature winding.

Secondly, the armature winding can be called “double layer.” In this case, a lateral notch formed by two adjacent half-notches can receive a portion of two different armature windings.

The two armature windings can be arranged in different manners in the notch.

According to a first embodiment, the notch can be “divided” by a median axis extending equidistantly from the teeth bordering the notch, so that each lateral half-notch 141 of a basic cell 13 receives a portion of a respective winding. This is the case shown in FIGS. 4c à 4e.

Alternatively, the notch can also be “divided” by an orthogonal median axis indicated earlier, extending between the teeth bordering the notch. This axis defines a first portion of the notch, common to the two half-notches, situated for example in the bottom of the notch, and which receives a portion of the first winding, and a second portion of the notch, situated between the first winding and the edge of the notch, and which receives the other winding.

In this case, it is preferably provided that the armature windings are arranged so that there is no winding crossing.

The distribution of the windings then varies depending on the number of phases and their disposition.

For example, it is possible to choose to distribute the armature windings so that the windings of the same phase are all wound around the adjacent basic cells. For example, in FIG. 4d, the machine 1 includes two windings per armature phase, and each armature winding is wound around the teeth of a basic cell, the two windings of each phase being wound around two adjacent basic cells. It is noted that in this configuration in which the windings of each phase are wound around the respective adjacent basic cells, the machine does not comprise any winding crossing.

Alternatively, it is possible to choose to altemate the armature windings of the different phase so that n successive cells of the stator comprise windings of n different armature phases.

For example, in FIG. 4e, each basic cell comprises an armature winding wound around its three teeth, and the armature windings of three consecutive cells belong to the three phase A, B and C.

FIG. 4c shows another example of a configuration in which the windings of a phase are grouped to surround the teeth of the adjacent cells (phase A) and the windings of the other phase are separated to alternately surround the teeth of the adjacent cells (phases B and C).

In a non-illustrated variant, the armature windings can also be distributed so as to cross.

### Disposition of the Teeth of the Stator

Preferably, all the central teeth of the stator have the same shape and the same dimensions, and all the lateral teeth also have the same shape and the same dimensions.

However, the central teeth can be different from the lateral teeth.

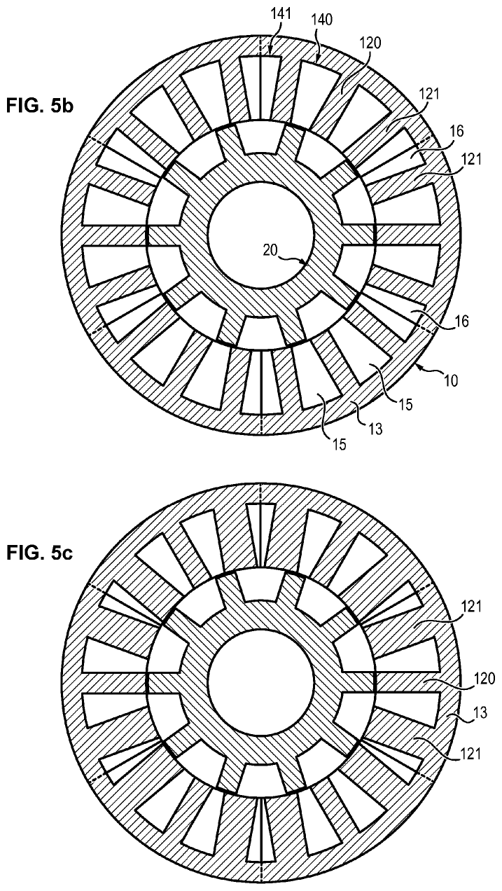

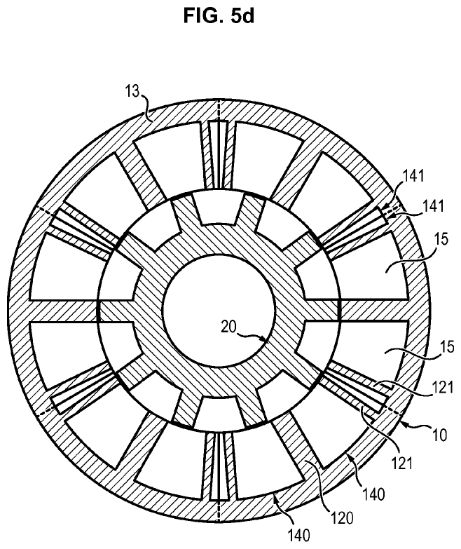

With reference to FIG. 5a, the notation conventions have been shown regarding the geometry of the teeth of the stator.

$$ϑ = \frac{2 π}{N}$$

denotes the angular opening of the average deviation between the teeth of the stator, N being the number of teeth of the stator.

The teeth 120 form central teeth of the basic cells can have a different width from those forming the lateral teeth 121.

θ_{c} is defined as the angular opening of the central teeth 120 of the basic cells of the stator.

The teeth 120 can have a constant width (measured in the tangential direction with respect to the axis of the stator).

As a variant, the teeth of the stator can have a trapezoidal shape, preferably having a width at their base 122 greater than the width at their top 123. The side of the tooth facing the teeth of the rotor is denoted the top 123, and the base 122 is the opposite side by which the tooth extends from the ring 11 of the stator.

This shape can be advantageous for reducing the concentration of magnetic flux at the base of the tooth so as to prevent the ferromagnetic material from saturating.

In every case, the angular opening θe of the central teeth is defined at the top 123 of the tooth.

In the case where the machine is of the linear type, the angular opening is replaced by the width of the tooth at its top.

We denote:

ϑ_{c}=β_{c}ϑ,

where β_{c} is a parameter characterizing the opening of the tooth, selected preferably comprised between 0.5 and 0.8, advantageously between 0.6 and 0.75.

Advantageously but optionally, the teeth 22 of the rotor have a width equal to the width of the central teeth 120.

Also defined is θᵢ the angular opening of the lateral teeth 121 of the basic cells of the stator. As previously, this opening is defined for the top 123 of a tooth. As previously, in the case of a linear machine, the angular opening is replaced by the width of the tooth at its top.

We denote:

ϑₗ=βₗϑ

where βₗ is a parameter characterizing the opening of the lateral tooth, preferably selected smaller than β_{c}, for example p, can be comprised between 0.4 and 0.7.

To illustrate the impact of the value of these parameters on the geometry of the teeth, two configurations of the stator have been shown by way of illustration in FIGS. 5b and 5c, in which respectively βₗ=β_{c}=0.5, and βₗ=0.52, and β_{c}=0.5.

Moreover, βₗ is de preferably selected less than β_{c} so that the lateral teeth are narrower than the central tooth for the same cell.

As has been seen with reference to FIGS. 2a and 2b, the central tooth and the lateral teeth alternatively form the passage of the magnetic flux. That fact of increasing the relative width of the central tooth with respect to the lateral teeth makes it possible to balance the sections for the passage of the magnetic flux.

Moreover, it also makes it possible to reduce the torque ripple generated during the operation of the machine.

Returning to FIG. 5a, the parameter a is also defined, translating a deviation of the relative positions of the lateral teeth 121 and the central tooth of a cell with respect to the average deviation between two teeth of the stator 10.

The average deviation has an angular opening θ already defined previously.

The deviation between a lateral tooth 121 and the central tooth 120 of the same cell is advantageously equal to θ(1+α), where α is preferably comprised between 0 and 0.15.

To illustrate the impact of the value of a on the disposition of the teeth of the stator, FIG. 5d shows an example in which α=0.3 with βₗ=0.2, and β_{c}=0.5

The fact of deviating the lateral teeth with respect to the central tooth also allows a reduction in the torque ripple and therefore a smoothing of the torque generated by the machine.

The proposed machine is more economical than the prior art machines because it does not include permanent magnets and it allows the windings to be distributed without crossing. It is also less voluminous and simpler to manufacture.

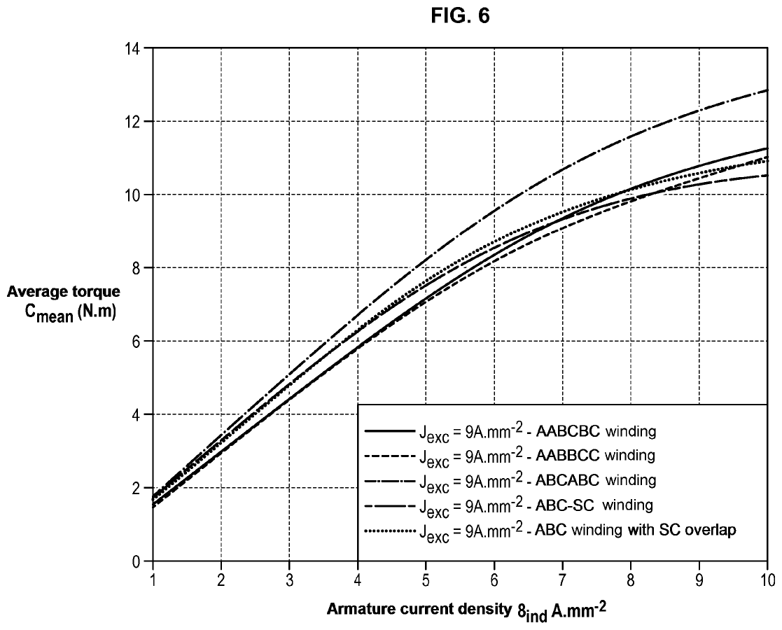

Even so, as visible in FIG. 6, it also has good performance because the theoretical average torque due to this machine is greater than that supplied by a prior art machine with simple excitation, and in certain cases to a machine with double excitation, that is one equipped with magnets.

The curves shown in this figure correspond to the winding variants illustrated in FIGS. 4a to 4e:
The curve “ABC-SC winding” corresponds to the single layer winding without crossing of FIG. 4a,
The curve “ABC winding with SC overlap” corresponds to a single layer winding with crossing of FIG. 4b,
The curve “AABCBC winding” corresponds to a double layer winding of FIG. 4c,
The curve “AABBCC winding” corresponds to the winding of FIG. 4d, and
The curve “ABCABC winding” corresponds to the winding of FIG. 4e.

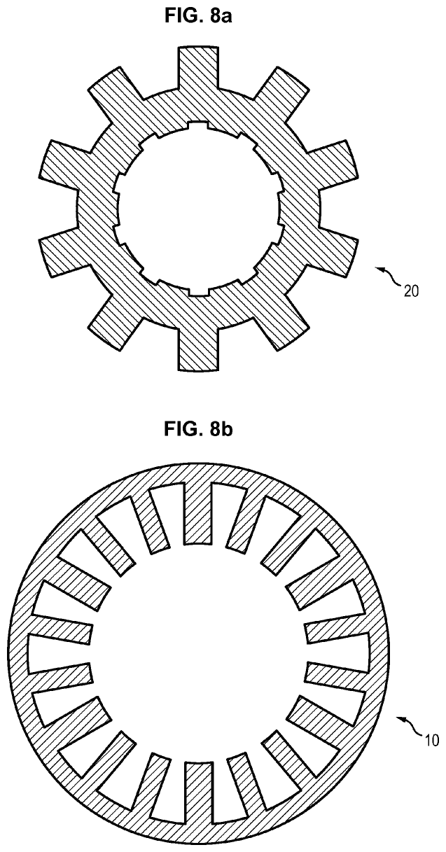

This theoretical performance has been validated by an experimental prototype of which the rotor and stator plates are shown respectively by FIGS. 8a and 8b. The outer diameter of the stator is 140 mm and the machine is in the form of a stack as in FIG. 7e, in which the length of the machine in the axial direction is 35 mm.

This prototype has allowed an average torque of 8.1 Nm to be obtained, against the theoretical value of 8.5 Nm, for an excitation current density of 15 A/mm².

1. A flux-switching electrical machine (1) comprising:
a movable element (20), comprising a plurality of flux-switching teeth (22), and
a stator (21), comprising a plurality of teeth (12), excitation windings (15) and armature windings (16),
characterized in that the stator is formed of a succession of basic cells (13) each comprising:
three teeth (12), comprising a central tooth (120) and two lateral teeth (121), delimiting between them two central notches (140), an excitation winding (15) being accommodated in the central notches (140) and wound around the central tooth (120), and
two lateral half-notches (141) on either side of the lateral teeth (121), each half-notch accommodating at least in part an armature winding (16), so that two successive basic cells share a common lateral notch.

2. The flux-switching electrical machine (1) according to claim 1, wherein the central tooth (120) of a basic cell (13) of the stator (10) comprises a top (123) having an angular opening (θ_{c}) comprised between 0.6*θ and 0.75*θ, where θ is the angular opening of the average deviation between two consecutive teeth of the stator, defined by
$$ϑ = \frac{2 π}{N} ,$$
where N is the number of teeth of the stator.

3. The flux-switching electrical machine (1) according to one of the preceding claims, wherein each lateral tooth (121) of a basic cell of the stator (10) comprises a top (123) having an angular opening (θₗ) comprised between 0.4*θ and 0.7*θ, where θ is the angular opening of the average deviation between two consecutive teeth of the stator, defined by
$$ϑ = \frac{2 π}{N} ,$$
where N is the number of teeth of the stator.

4. The flux-switching electrical machine (1) according to one of the preceding claims, wherein the lateral teeth (121) of a basic cell (13) of the stator are distant from the central tooth (120) by a deviation comprised between θ and 1.15*θ, where θ is the angular opening of the average deviation between two consecutive teeth of the stator, defined by
$$ϑ = \frac{2 π}{N} ,$$
where N is the number of teeth of the stator.

5. The flux-switching electrical machine (1) according to one of the preceding claims, wherein the teeth (12) of a basic cell (13) of the stator (10) have a width at their base (122) greater than the width at their top (123).

6. The flux-switching electrical machine (1) according to one of the preceding claims, wherein the armature windings (15) are distributed into a number Q of armature phases greater than or equal to 1, and the stator comprises a number N of teeth such that
N=3nQ
where n is the number, greater than or equal to 1, of windings per armature phase.

7. The electric machine (1) according to claim 6, the machine being of the rotary machine type and the movable element being a rotor, characterized in that N is even and the number of teeth (22) of the rotor (20) is even.

8. The electric machine (1) according to one of the preceding claims, wherein each armature winding (16) is received in the two lateral notches (141) of a basic cell (13) and wound around the three teeth (12) of the cell (13).

9. The flux-switching electrical machine (1) according to one of the preceding claims, wherein the armature windings (16) are disposed so that there is no crossing between them.

10. The flux-switching electrical machine (1) according to claim 6 in combination with one of claim 8 or 9, wherein each basic cell (13) comprises an armature winding (16) wound around its three teeth (12) and the armature windings (16) are distributed into three phases A, B and C disposed so that:
the windings of the same phase are wound around the teeth of adjacent cells, or
the windings of three consecutive cells all correspond to a different phase.

11. The flux-switching electrical machine (1) according to one of claims 1 to 10, wherein the lateral notches (141) of at least one basic cell (13) accommodate portions of different armature windings (16).

12. The flux-switching electrical machine (1) according to one of the preceding claims, wherein each basic cell (13) of the stator (10) further comprises at least one permanent magnet (17).

13. The electric machine (1) according to claim 12, wherein each basic cell comprises a permanent magnet (17) accommodated in the central tooth (120) or two permanent magnets (17) received respectively in the central notches (140).

14. The electric machine (1) according to one of claim 12 or 13, said machine comprising an axial stack of stators (10) and movable elements (20), wherein only a fraction of the stator length (L) includes permanent magnets.
